(19) United States
(12) Patent Application Publication
(10) Pub. No.: US 2025/0086525 A1
(43) Pub. Date: Mar. 13, 2025

(54) ROOM SCHEDULING SYSTEM

(71) Applicant: Steelcase Inc., Grand Rapids, MI (US)

(72) Inventors: James LUDWIG, Grand Rapids, MI (US); Andrew GOODE, Grand Rapids, MI (US); Justin Glen BEITZEL, Grand Rapids, MI (US); Julia Andress OLSON, North Palm Beach, FL (US); Morrison Lee CUNNINGHAM, Grandville, MI (US)

(21) Appl. No.: 18/958,450

(22) Filed: Nov. 25, 2024

Related U.S. Application Data
(63) Continuation of application No. 16/472,383, filed on Jun. 21, 2019.
(60) Provisional application No. 62/479,357, filed on Mar. 31, 2017.

(51) Int. Cl. G06Q 10/02; G06F 3/02; G06F 3/0362; G06Q 10/1093; G08B 5/36

(52) U.S. Cl. CPC G06Q 10/02; G06Q 10/1095; G08B 5/36; G06F 3/02; G06F 3/0362

(57) ABSTRACT

A room scheduling device is disclosed that provides a dial or knob for turning to adjust time being reserved. The room scheduling device further includes a tactile button to activating the device and setting a reservation after a duration has been selected via the dial. The room scheduling device further includes a software application running on a personal electronic device such as a smartphone. The software application identifies the room scheduling device via an identifier and then displays information from an electronic calendar system as an augmented reality. The system can further include an identifier on an exterior wall of the room that allows the software application to identify the space from a greater distance to allow users to identify and reserve space from a distance away from the room.

### CROSS-REFERENCE TO RELATED APPLICATIONS

This application is a continuation of U.S. patent application Ser. No. 16/472,383, filed on Jun. 21, 2019, which is a national phase application under 35 U.S.C. § 371 of International Application No. PCT/US2018/024013, filed on Mar. 23, 2018, which application claims the benefit of U.S. Provisional Application No. 62/479,357, filed on 31 Mar. 2017, all of which applications are incorporated herein by reference in their entirety.

### STATEMENT REGARDING FEDERALLY SPONSORED RESEARCH OR DEVELOPMENT

Not applicable.

### BACKGROUND OF THE INVENTION

The present invention relates to systems for scheduling rooms such as offices or meeting spaces. More particularly, the invention relates to systems for making the reservations and availability of the spaces visible and easily identifiable.

### BRIEF SUMMARY OF THE DISCLOSURE

Most office environments provide a mechanism for reserving spaces such as meeting rooms via a software scheduling tool such as Microsoft Outlook or Google Calendar. The space is provided with an identification in the scheduling software to allow the user to view the schedule of that space and to reserve the space if it is available.

Conflicts may arise in this arrangement as a person may reserve the space in the calendar system but a local user may have no way to recognize the reservation absent checking the calendar system. In this situation, the local user, seeing the space empty, may enter and begin using the space. The user who made a reservation may come to the space later, expecting it to be empty and find the local user present in the space. This then requires the users to arbitrate the usage of the space with one of the users being required to find an alternative space. This results in loss of productive work time and may lead to frustrations among the coworkers. A similar problem occurs if a user checks the room calendar and sees it is reserved. However, many meetings that are scheduled for longer periods of time take less than the scheduled time. The room is thus available despite it appearing in use on the calendar system. Similarly, standing meetings may be scheduled to recur at specific times and frequently either do not take place or are greatly shortened based on events such as a lead participant being out of the office. In these situations, the space becomes underutilized because other potential users may not see that the space is available.

One solution to this problem is the use of room scheduling devices such as the RoomWizard by Steelcase. This room scheduling device provides a recognizable signal in the form of a green or red light that may be seen across an office space to indicate the immediate availability of the space. The room scheduling device further provides a screen with the detailed room schedule for the day. This allows a user to identify whether the room is available and, if so, for what duration of time. This solution is effective and provides the users the information needed at various distances.

When used properly, the RoomWizard delivers an effective solution for most of the issues with space scheduling. However, sometimes users may not properly use the room scheduling device resulting in improper signaling. For example, the RoomWizard includes a simple button labeled “Use Now” to allow a walk-up user the ability immediately to identify that the space is in use. By pressing the button, the user is then prompted to identify how long the space should be reserved. The space is then held as a local reservation for the selected period of time. Some users will simply walk up and enter the space, taking possession without providing the indication of a reservation. In this situation, the room scheduling device will continue to display a green light to indicate the space is available and the calendaring system will indicate the space is available despite the presence of a worker in the space. This may again lead to the need to arbitrate the space if another person either remotely reserves the space or, seeing the space as available from across the room, comes to use the space and finds the other user in the space.

In some applications, users would like a smaller, simpler room scheduling device that could allow a user to walk up and easily reserve the space. This could be used for smaller spaces or in spaces where the larger display of the RoomWizard is not desired. It would additionally be advantageous to provide a solution that could provide the detailed reservation information to the user from a greater distance, allowing the user to scan across the various spaces and quickly identify a space that will meet the needs for his/her use. It would also be advantageous in some environments to provide a solution that did not require a physical object to provide this functionality.

According to some aspects of the present disclosure, a simple room scheduling device is provided to identify whether a space is available and, if so, to reserve the space. The room scheduling device includes a dial with a peripheral indicator light. The light may provide either a solid indicator of the current status of the room via, for example, a red or green indicator. The indicator could be any alternative that is recognized by users from a distance to signal the status of the room, for example, no light when not in use and a blue light when reserved. The light may also provide the current status through other mechanisms such as a softer, warmer light provided with a gentle pulsing character. This approach avoids users becoming tired of the solid red and green lights.

The dial could additionally include a display that may provide an indication of the minutes remaining on the current reservation. This would allow a user approaching the area readily to identify whether the room will be available in a useful timeframe or whether it is blocked for an extended period. Additionally, this could allow a user approaching an empty space with a small amount of time remaining on the reservation to surmise that the previous user has completed his or her use and the space is now available.

The dial could also include a rotational sensor and a push button for user input. For example, if a user approached a room scheduling device presenting a green peripheral light indicating the space was available, the user could turn the dial to select a duration of intended use. If the room is not reserved for the selected time, the room scheduling device may present the amount of time corresponding to the rotation of the dial. For example, the user could rotate the dial and the indicator light would first display “15” indicating the user has selected a 15-minute duration. As the user continues to rotate the dial, the indicator would increase this value in 15 minute increments. The dial could alternatively increase or decrease the selected time in other increments, for example, 1 minute, 5 minutes or greater amounts. When the user selected the desired amount of time, the user may then press the dial, activating the push button and the set time will be selected for a reservation. The peripheral indicator light would then change to red or similar color to indicate the room is now reserved and is no longer available.

In another embodiment, the detailed calendar information could be provided via an augmented reality application on a personal electronic device such as a cell phone or tablet device. The room scheduling device could include a mounting structure that includes an identifier recognized by software to identify the space. The identifier would preferably be a pleasing aesthetic design. Thus, when a user of the personal electronic device points a camera associated with the personal device at the designated identifier of the room scheduling device, the application may recognize the identifier on the room scheduling device and pull detailed schedule information from the enterprise scheduling software. Detailed schedule information may then be presented on the personal electronic device screen around the image from the camera on the personal electronic device of the room scheduling device. This additional layer of information may be provided when a user needs specific information. For example, if a user wants to know who has a space reserved, they may use the augmented reality application to look at the room scheduling device and see the detailed information.

In another embodiment, the identifier for the room scheduling device is integrated into the wall or panel system for the work space. A pattern could be included in a fabric used on the wall or a pattern could be placed over the existing wall covering. This pattern could be made to not be readily visible to the naked eye, but identifiable using the camera on the personal electronic device. Alternatively, the pattern could be decorative while still being visible to the naked eye. In some embodiments, the pattern included on the wall or fabric may be at a scale sufficient to allow identification by the application on the personal electronic device at a greater distance and thus allow a person standing at a great distance, for example across a large space, immediately to view availability and detailed schedule information without having to approach each individual space via the augmented reality application.

In another embodiment, the local room scheduling device would not be required and the user could rely entirely on the augmented reality application. An identification pattern could be provided on the spaces that may be scheduled and no local room scheduling device would be required to be present. The user would always have to utilize the application on the user's personal electronic device or other personal device in order to access the availability and detailed schedule of the space.

To the accomplishment of the foregoing and related ends, various embodiments may comprise one or more of the features hereinafter fully described. The following description and the annexed drawings set forth in detail certain illustrative aspects. However, these aspects are indicative of but a few of the various ways in which the principles may be employed. Other aspects, advantages and novel features will become apparent from the following detailed description when considered in conjunction with the drawings.

### BRIEF DESCRIPTION OF THE SEVERAL VIEWS OF THE DRAWINGS

FIG. 1 shows a plan view of an office environment.

FIG. 2 shows a plan view of a head's down office environment.

FIG. 3 shows a plan view of a conference space.

FIG. 4 shows a plan view of an informal destination space.

FIG. 5 shows a room scheduling device of the current invention.

FIG. 6 shows a room scheduling device in an alternative state of the current invention.

FIG. 7 shows a schematic for the preferred embodiment of the current invention.

FIG. 8 shows a personal electronic device running a software application according to the present invention.

FIG. 9 shows a personal electronic device running an augmented reality software application according to the present invention with the room occupied not reserved.

FIG. 10 shows a personal electronic device running an augment reality software application according the present invention with the room occupied and reserved.

FIG. 11 shows an alternative office environment having identification panels on reservable spaces.

FIG. 12 shows an alternative office environment having alternative identification panels on reservable spaces.

FIG. 13 shows a personal electronic device running an augmented reality software application identifying a space for an upcoming meeting.

FIG. 14 shows a personal electronic device running an augmented reality software application identifying an available space.

FIG. 15 shows a personal electronic device running an augmented reality software application identifying an available space and providing a slider for setting a time.

FIG. 16 shows a personal electronic device running an augmented reality software application providing a 3d image of a selected space.

FIG. 17 shows a personal electronic device running an augmented reality software application identifying the type of an available space.

FIG. 18 shows a personal electronic device running an augmented reality software application identifying a space and providing information about the space.

FIG. 19A shows a personal electronic device running an alternative augmented reality software application.

FIG. 19B shows a personal electronic device running an alternative augmented reality software application.

FIG. 19C shows a personal electronic device running an alternative augmented reality software application.

FIG. 19D shows a personal electronic device running an alternative augmented reality software application.

FIG. 19E shows a personal electronic device running an alternative augmented reality software application.

FIG. 19F shows a personal electronic device running an alternative augmented reality software application.

FIG. 20A shows an alternative display arrangement for the room scheduling device.

FIG. 20B shows an alternative display arrangement for the room scheduling device.

FIG. 20C shows an alternative display arrangement for the room scheduling device.

FIG. 20D shows an alternative display arrangement for the room scheduling device.

FIG. 20E shows an alternative display arrangement for the room scheduling device.

FIG. 20F shows an alternative display arrangement for the room scheduling device.

FIG. 20G shows an alternative display arrangement for the room scheduling device.

FIG. 20H shows an alternative display arrangement for the room scheduling device.

FIG. 20I shows an alternative display arrangement for the room scheduling device.

FIG. 20J shows an alternative display arrangement for the room scheduling device.

### DETAILED DESCRIPTION OF THE INVENTION

Various aspects are now described with reference to the annexed drawings, wherein like reference numerals correspond to similar elements throughout the several views. It should be understood, however, that the drawings and detailed description hereafter relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software or software in execution. For example, a component may be, but is not limited to being a process running on a processor, a processor, an object, a machine-readable set of instructions, a thread of execution, a program and/or a computer. By way of illustration, both an application running on a computer and the computer may be a component. One or more components may reside within a process and/or thread of execution and a component may be localized on one computer and/or distributed between two or more computers or processors.

The word “exemplary” is used herein to mean serving as an example, instance or illustration. Any aspect or design described herein as “exemplary” is not necessarily to be construed as a preferred or advantageous over other aspects or designs. Of course, those skilled in the art will recognize many modifications may be made to this configuration without departing from the scope or spirit of the claimed subject matter.

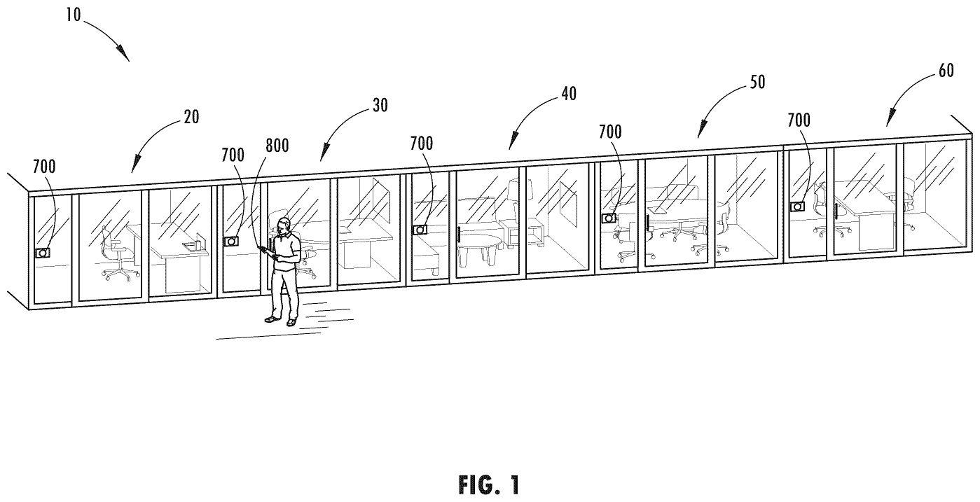

Referring now to the drawings wherein like reference numerals correspond to similar elements throughout the several views and, more specifically, referring to FIG. 1, an exemplary office space 10 is shown. Included in the office space 10 are several enclosed meeting spaces 20,30,40,50,60. Each meeting space may have several amenities such as video display screens, lounge seating, office seating, tables, whiteboards and other similar amenities. The amenities provided in a given space are generally selected to facilitate the type of activity that is anticipated in the space. For example, heads down enclave 20 shown in FIG. 2 is arranged for an individual to retreat from office space 10 and avoid interruptions while working in a concentrated manner. Heads down enclave 20 as shown in FIG. 2 may include, among other items, a desk 210, a light 220, a whiteboard surface 230 and an office chair 240. The space could also include a monitor (not shown) for a user to connect to his or her portable device or a computer with a monitor (not shown) that would allow the user to connect to a network to facilitate work.

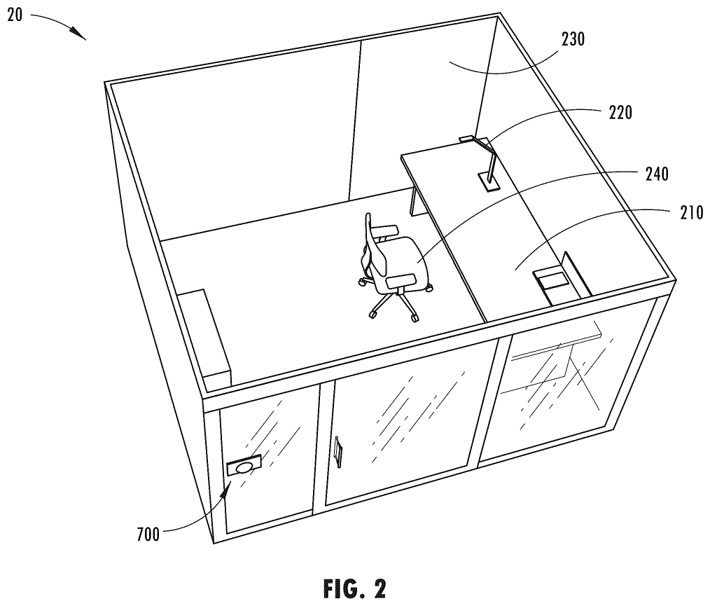

Another type of space with different amenities is illustrated as collaboration space 30 shown in FIG. 3. Collaboration space 30 is intended to facilitate generative or presentation meetings of multiple people. In these types of meetings, it is common for users to need to share content. This content may be shared with the intent of presenting information by a leader or to generate information using a common display. This type of space may include amenities including a table 310, a display screen 320, a whiteboard 330 and chairs 340. Other amenities could be included that would further assist collaborative work as well.

Another type of space with different amenities is illustrated as informal destination space 40 shown in FIG. 4. Informal destination space 40 is intended to be used as a space to connect, share and build trust before, during or after a meeting. The space includes a display screen 410 which may be used for videoconferencing or may have a news or entertainment feed. This provides a more comfortable place to relax and refresh during a busy work day. Instead of office seating, a sectional lounge 420 is provided. Sectional lounge 420 creates a relaxed, comfortable environment for one or two to share without intruding on one another's personal space. Informal destination space 40 may include other amenities to reinforce the informal atmosphere. These may include a coffee table 430 and an end table 440. Informal destination space 40 may also include a whiteboard 450 to allow users to have a space to collaborate.

Other types of spaces may be envisioned that could have different amenities. These could be for performing other types of work and could include interactive displays, teleconferencing equipment, video conferencing equipment and other similar amenities.

Additionally, some spaces will provide more seating than other spaces. All of these factors are important considerations when a user selects a space for work.

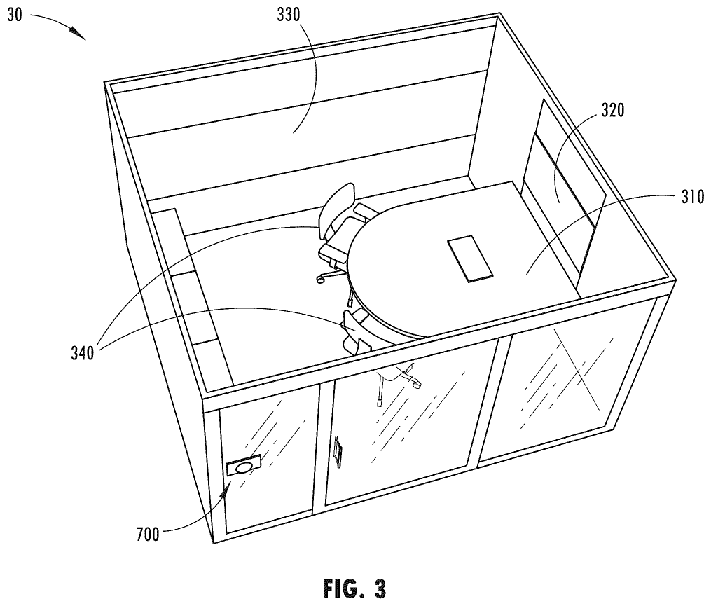

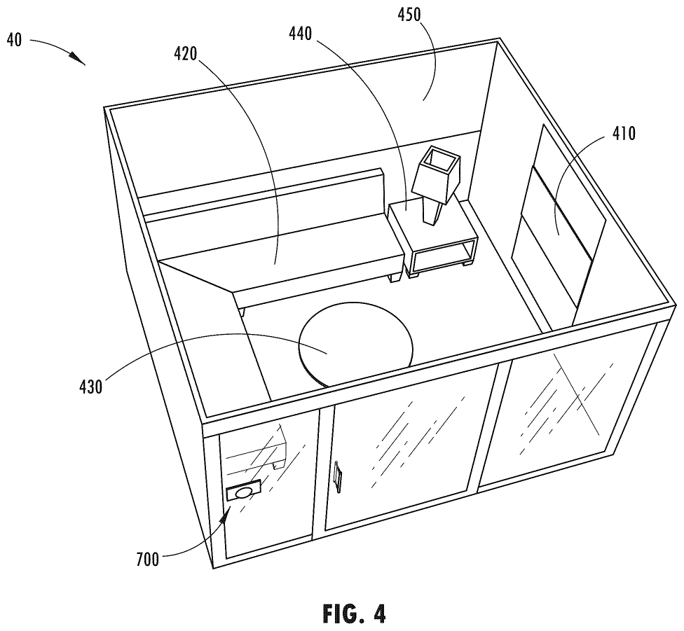

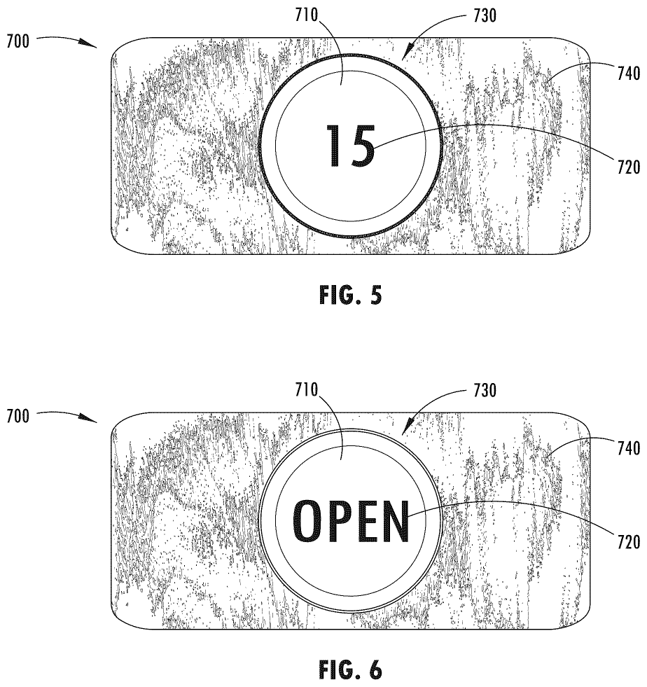

Many spaces include a room scheduling device 700 as shown in FIG. 5. This type of room scheduling device may provide an easy way to make a local reservation and immediately to identify from a distance whether the space is currently reserved or available. In one embodiment, room scheduling device 700 includes a background support 740. Background support 740 may be constructed of any supportive material but is shown fabricated from wood with a wood grain. Room scheduling device 700 further includes an indicator dial 710. Indicator dial 710 is used to signal the current use status of the room. Indicator dial 710 includes a display edge 730 that lights up with a red color to indicate the room is in use when it is reserved. The center of the indicator dial further includes a counter 720 that displays the number of minutes remaining in the current reservation. As shown in FIG. 5, the room is reserved and there are 15 minutes remaining in the reservation.

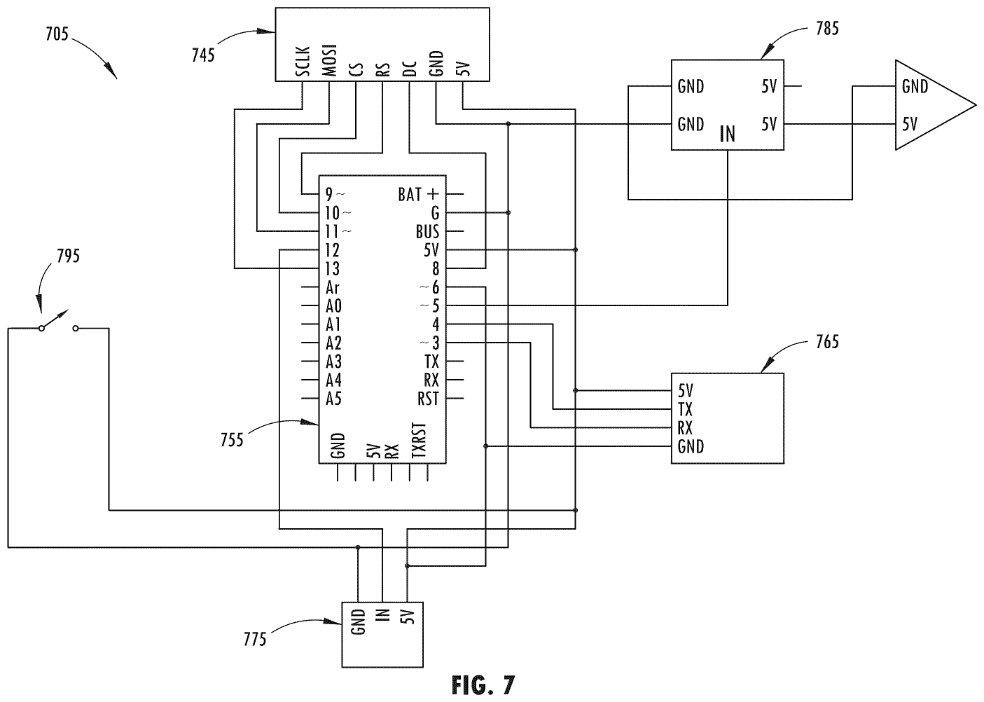

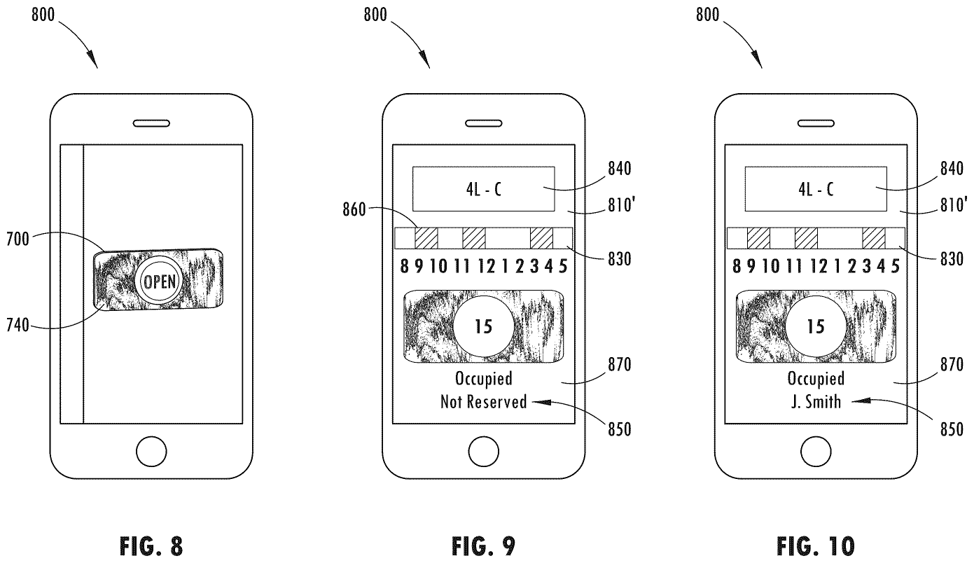

A circuit diagram 705 for an exemplary room scheduling device 700 is shown in FIG. 7. The counter 720 is implemented using the OLED display 745. The unit is implemented using an Adafruit Pro Trinket 5 volt microcontroller 755. The microcontroller 755 includes a processor and system memory. Inputs to the microcontroller 755 include the TTL Serial Camera 765 and the rotary encoder 775 which is connected to the indicator dial 710 to provide the indication a user turning the indicator dial 710. The tactile button 795 provides an input to the microcontroller 755 indicating activation of the push button. The room scheduling device 700 further includes an Adafruit Neopixel Ring 785 which acts as the display edge 730 around the indicator dial 710. A software application developed using the Arduino integrated development environment is loaded into memory containing the instructions to perform the functions described below.

The room scheduling device 700 includes a camera 765. The camera 765 can be incorporated into the indicator dial 710 or located close to the room scheduling device 700. The camera 765 is directed away from the indicator dial 710. The software in the microcontroller 755 analyzes the output from the camera 765 and identifies human characteristics. This is used to identify physical proximity of a person. The microcontroller 755 uses this input to put the counter 720 in and out of a sleep mode.

When the microcontroller 755 detects the proximity of a person via the camera 765, the counter 720 is activated. The transition is managed to gently increase the brightness of the counter 720 so as to avoid a sudden and stark increase in brightness. After a predetermined period of time with no further recognition of a person's presence, the system goes in to sleep mode. In this mode, the counter 720 is turned off. Utilizing the sleep mode helps eliminate an overabundance of lighted screens in the workplace. In the preferred embodiment, the display edge's 730 lighted state is not changed by the sleep mode. This allows users at a distance from the space to continue to be able to scan multiple room scheduling devices 700 mounted on walls to identify available spaces. An alternative to this is to use the sleep mode to also turn the display edge 730 to an off state when no presence is detected. It would also be possible for the camera 765 to be replaced with an alternative sensor such as a thermal detector or a passive infrared sensor in order to identify the presence of a person. It would also be possible for the sensor to provide data via a wireless signal to the microcontroller 755. It would also be possible for the sensor to provide data via a network connection or for the data to be provided to a cloud-based application that provided the data to the microcontroller 755 via an application programming interface (API) or other interface.

When the room is reserved, display edge 730 and counter 720 provide a visual indicator that may be seen from across the workspace. In this way, if a user is looking for a space to use, he or she may easily look across the space and identify unreserved spaces. The reliability of the indicators could be increased by further adding an occupancy sensor (not shown) to the space. The occupancy sensor could use passive infrared or similar available technology to recognize the presence of a user in the space. The sensor could provide data to the microcontroller 755 via a wired or wireless connection. Alternatively, the sensor could provide data to the microcontroller 755 over a wireless or network connection. If a user enters the space when it is not reserved, display edge 730 and the counter 720 could change to provide the red light indicating the space is in use.

Indicator dial 710 further includes a tactile button 795. The tactile button 795 may be provided as a physical push button, although it should be known that any actuation system could be used. When a user approaches room scheduling device 700 to use an open space, he or she may quickly and easily reserve the space. The user presses indicator dial 710 to actuate the tactile button 795. Display edge 730 immediately changes to a red light. Indicator dial 710 further includes a rotational sensor 775. After pressing indicator dial 710, the user may rotate it clockwise to increment the time of the reservation displayed on counter 720. The user may correct an over-rotation by turning indicator dial 710 counter-clockwise to decrement the time displayed on counter 720. If there is an upcoming reservation for the space, the amount of time allowed for the local reservation will be limited to the amount of time remaining before that reservation begins. If the user continues to turn the indicator dial 710, the counter 720 may remain at the available amount of time or alternatively provide a signal that the room is reserved beyond the current indication. This could be accomplished by, for example, gently flashing or pulsing the display edge 730 or changing the color of the display edge 730 to another color. This allows the user to quickly and easily reserve the space and identify the time available for the space should there be a need to make use of it.

An alternative approach to reserving the space that is even easier for the user utilizes the camera 765. When the microcontroller 755 recognizes the presence of a user via the camera 765 as discussed previously, the indicator dial 710 becomes active and the counter 720 is activated. If the microcontroller 755 senses a rotational activation of the rotational sensor 775 indicating the indicator dial 710 is being rotated, the microcontroller 755 interprets this to indicate the user is making a reservation. This eliminates the need to activate the tactile button 795 by depressing the indicator dial 710 as discussed above. The making of the reservation is handled in a similar fashion to that discussed above.

When a user is finished using the space, it would be advantageous to release the space for future users. This may be accomplished in a number of ways. Dial 710 could be pushed quickly twice to release immediately a current reservation. Alternatively, the user could press dial 710 once and then turn dial 710 counter-clockwise until the counter 720 decrements to 0. Alternatively, microcontroller 755 can sense the presence of a user via camera 765 and if the room is currently in use and the microcontroller 755 senses depressing of the indicator dial 710 via the tactile button 795 the microcontroller 755 interprets this action as intended to end the current reservation. The microcontroller 755 thus releases the current reservation and frees the space for a new reservation.

Turning to FIG. 6, room scheduling device 700 is shown when the space is not reserved. Display edge 730 is left black and not illuminated. Alternatively, indicator dial 710 could be illuminated in a green or white color to indicate the space is available. Counter 720 may either be left dark and not provided as an indicator or, as shown, it could be illuminated with an indication that the space is “Open” or available. Counter 720 is shown providing a white light, but it could be any color such as green to indicate the space is available. In this way, a user may quickly and easily see that the space is available and not reserved.

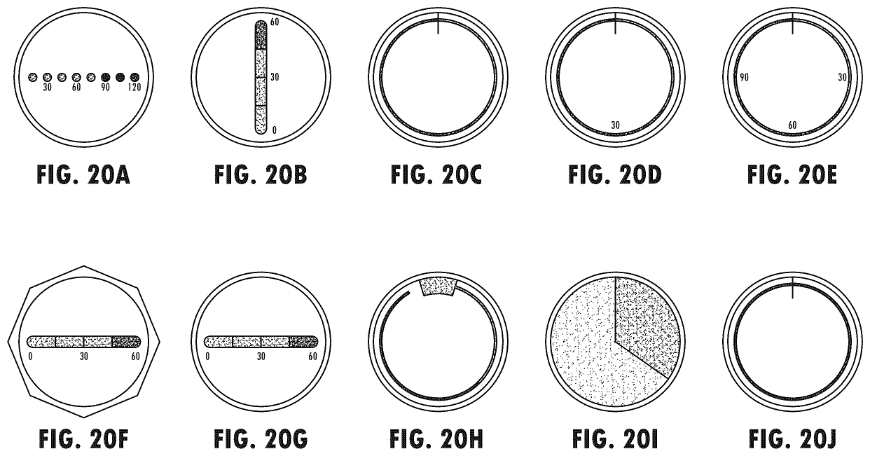

Counter 720 could also provide other useful information. For example, if counter 720 pulsed on and off, it could signal that a meeting was scheduled in the space in the near future. As the time of the scheduled meeting came closer, counter 720 could pulse faster to signal less time was available. This could assist a local user looking for a room. If the room is needed for a short period of time (as, for example, to take a quick phone call), it would be possible for the user to take the room with the flashing indicator knowing that another meeting is going to be starting there soon. Another alternative to signal that there is an impending meeting would be to show the number of minutes until the next scheduled meeting on counter 720 in white. This could either be pulsing or simply presented in solid lighting. This number could then count down until the next meeting began. In this way, the user would see exactly how much time is remaining until the next event for the room. It would also be possible for the counter 720 to include other information including the day's schedule for the associated space. Examples of possible displays conveying the space's schedule are shown in FIG. 20A-20J. Typically, the times when the space is available would be shown in green while the times when it is scheduled would be shown in red.

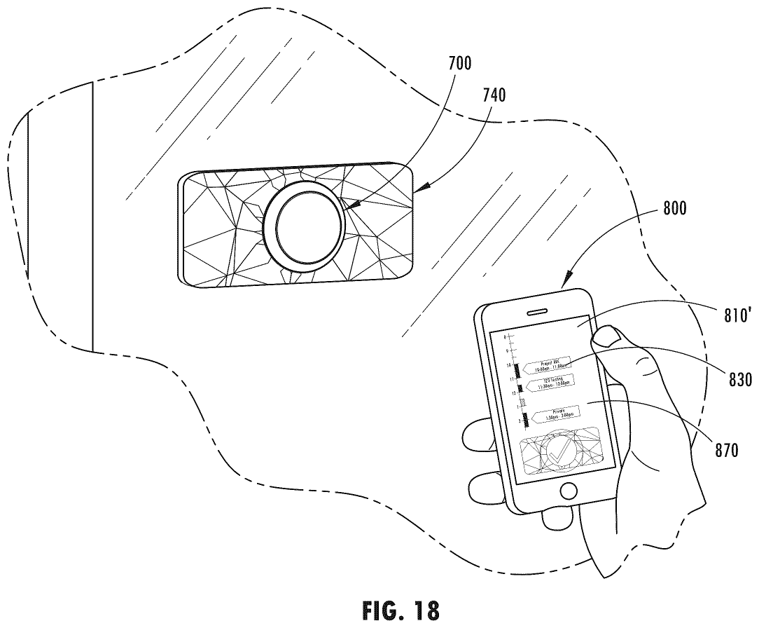

A software application is associated with the system to provide further functionality. The software application works as augmented reality, providing additional details and assistance to the user. The software application utilizes a sensor to identify a particular room scheduling device 700. In the preferred embodiment, this is accomplished using the camera 765 on a personal electronic device 800 such as a smartphone or tablet as illustrated in FIG. 18. The user activates the application and the personal electronic device 800 uses the camera 765 on the personal electronic device 800 to display an image of the space on the screen 870 as shown in FIG. 18. The application then recognizes the unique material and pattern used for background support 740 of room scheduling device 700 and looks it up in a database. The database provides the space identifier and allows room scheduling device 700 to access the electronic calendar associated with the space. The electronic calendar is accessed using APIs or connector software. The data related to the room is accessed and presented on the screen 870 around the image of room scheduling device 700. The background support 740 needs to have a unique pattern that can be recognized by the personal electronic device 800. The pattern can be lines as illustrated in FIG. 18, dots or the grain pattern in a wood background support 740 as shown in FIG. 5. Any material is acceptable provided it is a unique pattern that can be identified by the personal electronic device 800.

A personal electronic device 800 with the application software running is illustrated in FIG. 9. A room scheduling device 700 is viewable in the screen 870. A wall 810′ around scheduling device 700 is also visible around the room scheduling device 700 in the screen 870. Superimposed onto the image of wall 810′ is the information pulled from the calendar system. For example, the application may provide a schedule summary 830 showing the entire day's schedule. This allows the user to quickly identify the blocks of time during which the space is already reserved and when it is available. As shown, the times when the space is reserved are blocked in a darker shade 860. In a exemplary application, this darker shade 860 could be red since users will recognize this as reserved time. A name of the space 840 is provided at the top of the display. This is frequently helpful in large organizations as users are invited to meetings in spaces they do not frequently visit. In this type of situation, the user may have a meeting notice that identifies the space and the user can compare the name of the space 840 with the name given in the meeting notice. The display further includes a message 850 to indicate the space's current status. As shown in FIG. 9, the space is occupied by a user, but it is not properly reserved. This could be, for example a situation where a person entered the space without using the room scheduling device 700. The system recognized the presence of the person as highlighted above and changed the state to occupied, but continued to identify that there was no reservation associated with this use. FIG. 10 shows an example where the space is reserved by J. Smith in the message 850. The message 850 could further include information such as the detailed information about the meeting taking place.

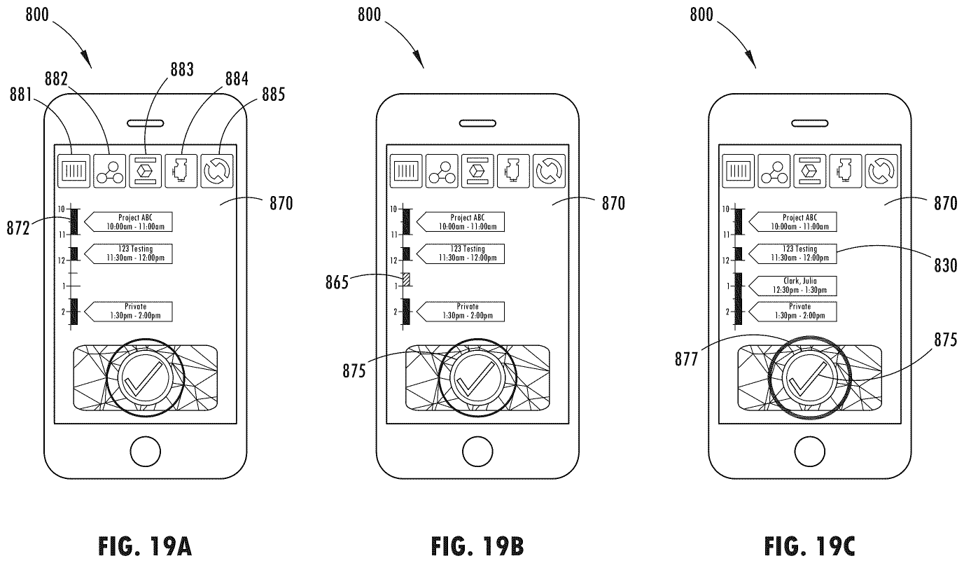

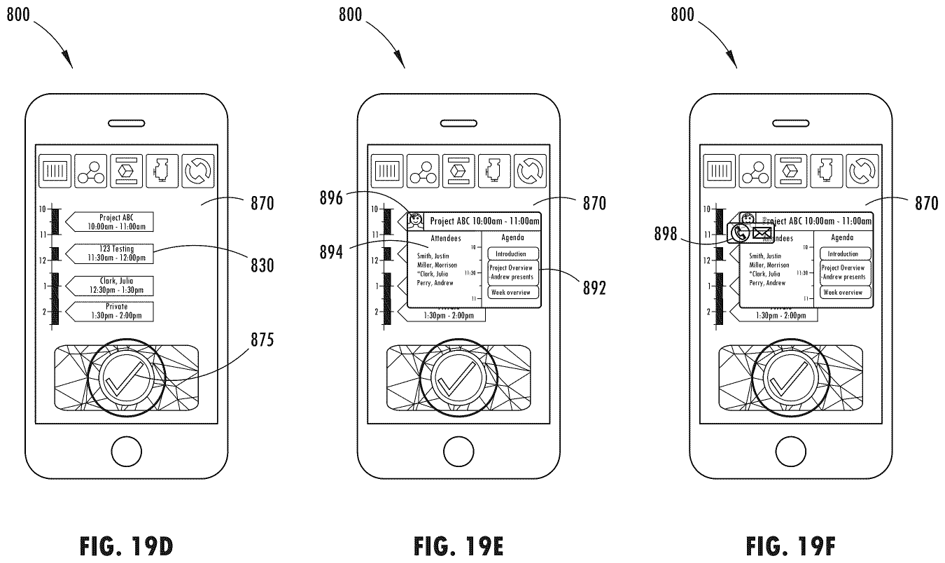

An alternative embodiment to the above reference personal device application is illustrated in FIGS. 19A-F. FIG. 18 shows personal device 800 with the software application active. The camera 765 on the personal device 800 is directed towards the room scheduling device 700. The background support 740 includes a pattern that identifies the related space. The software application identifies the space based on the pattern and presents an initial augmented reality overlay on the image on the screen 870. The initial display on the screen 870, also referred to as the “home” screen, shows the current schedule summary 830 associated with the room.

From the home screen, the user can perform a number of actions. An example of actions that can be taken is illustrated in FIGS. 19A-F. In FIG. 19A, the home screen is visible in the screen 870 of the personal electronic device 800. The room has been identified by the system and the schedule for the day is shown on the screen 870. In FIG. 19B, the user has identified a time desired for scheduling the space. As shown, the user has selected the time from 12:30-1:00. This is indicated by the hatched line 865 along the time line. The user would then press the check mark 875 superimposed over the indicator dial 710 to complete the reservation. FIG. 19C shows a success indicator 877 being provided to the user upon activating the check mark 875. This feedback is provided in order to positively indicate the user has succeeded in making the reservation. They system could alternatively use other feedback including haptic feedback via the personal electronic device 800. The success indicator 877 appears only temporarily to provide feedback. FIG. 19D shows the screen 870 after the success indicator 877 is no longer visible. Using the AR function to make the reservation has the benefit of identifying the owner of the reservation in the calendar system.

The software application can provide additional functionality. For example, in FIG. 19E, the user has selected one of the events scheduled for the space. Additional information related to the selected event is displayed on the screen 870. In this example, the information includes an agenda 892 for the event on the right side of the screen 870. The information further includes attendees 894 on the left side of the screen 870. Additionally, a photo and the name of the organizer 896 are displayed at the top of the screen 870. FIG. 19F illustrates the action taken if the user selects the organizer 896 on the screen 870. Two icons appear 898 to allow the user to either phone or email the organizer 896. This could be useful, for example, if an organizer has reserved the space but is not present. The user could call or email the organizer by selecting the appropriate icon 898.

One issue identified with the augmented reality application is that the user must hold the personal electronic device 800 with the camera 765 directed towards the room scheduling device 700 in order to continue to view the augmented information. In order to make it easier to view this information, the user can activate a freeze mode by selecting the hold button 883 at the top of the screen 870. Upon activation of the hold button 883, the image is frozen on the screen 870. The application functionality is still available to the user, but they no longer have to maintain the camera 765 in a position directed at the room scheduling device 700. Other functionality could be provided via the buttons 881,882,883,884,885 including a refresh function, operation of connected objects and affordances such as lighting, heating, displays and other devices, access to additional digital objects related to the room including documents attached to events to which the user is invited and related information. It is envisioned that these buttons could be used for many additional activities and these are exemplary of what could be used.

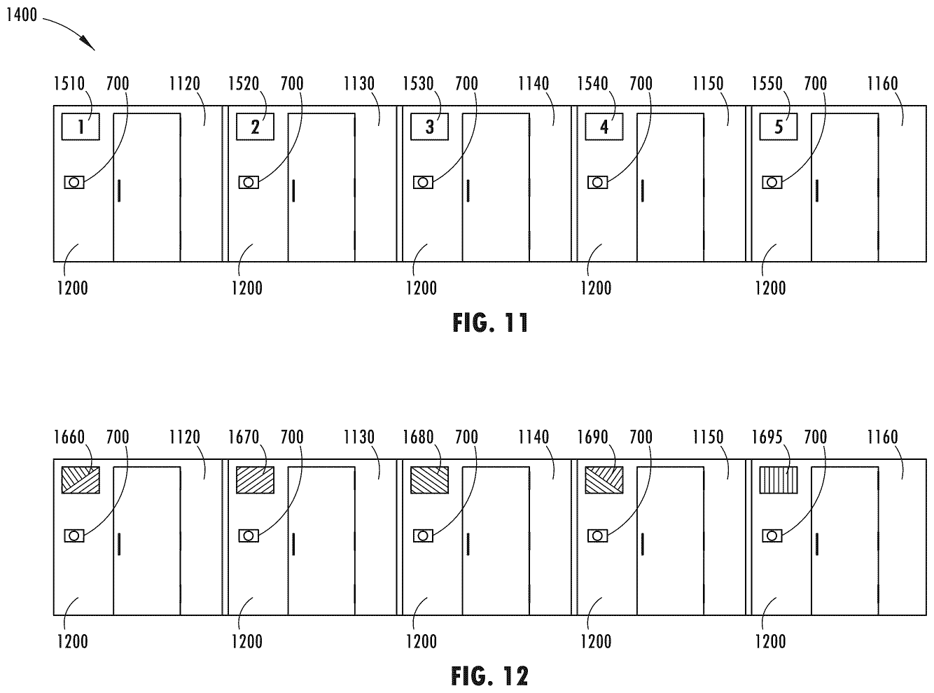

An extension of this room scheduling concept allows the user to view space availability and affordances in the spaces from across the room. This may be accomplished by having a pattern on the exterior wall covering of the spaces. This embodiment is shown in FIG. 11. In this example, each of the rooms, 1120,1130,1140,1150,1160 has an exterior wall 1200 facing away from an interior of the spaces. This exterior wall 1200 faces an open space within the office 1400. The exterior wall 1200 includes an identification panel 1510, 1520, 1530, 1540, 1550 on each of the respective rooms 1120, 1130, 1140, 1150, 1160. Each identification panel 1510, 1520, 1530, 1540, 1550 includes a unique pattern that is stored in a database associated with the respective room. This identifier may be as simple as a number as shown in FIG. 11 or could be a decorative pattern that is unique to each room. For example, in FIG. 12 the user of a pattern of lines 1660,1670, 1680, 1690, 1695 is used similar to a bar code to identify each of the rooms 1620, 1630, 1640, 1650, 1660. A similar option would be to provide a pattern that is more subtle and not discernible by the naked eye. This could be accomplished either via very slight contrast in printed material that hides the pattern from easy viewing. Other approaches could also be used to make the pattern viewable to the camera 765 in the personal device but not to the naked eye.

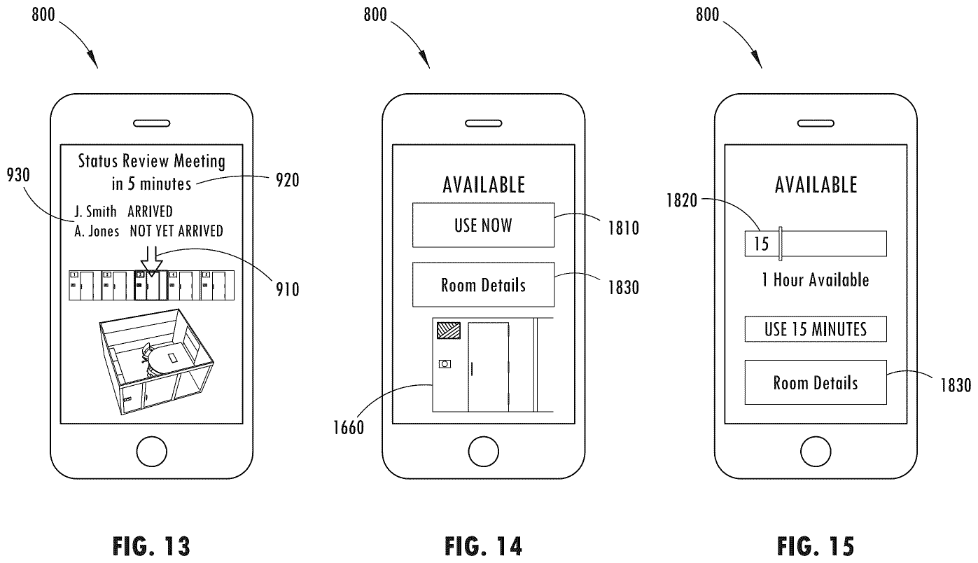

In this embodiment, the software presents a real-time image from the camera 765 on the display. As the user scans the camera 765 across the identification panel 1510, 1520, 1530, 1540, 1550 on each of the respective rooms 1120, 1130, 1140, 1150, 1160 the identification panel 1510, 1520, 1530, 1540, 1550 is compared with the patterns stored in the database and the room associated with the pattern is identified. The system can then provide additional information about the room via the display over the image of the room. For example, as shown in FIG. 13, by receiving data from the user's electronic calendar, the system could identify that the user has a meeting in a particular room scheduled in five minutes. In this case, when the user scans the room where the meeting is scheduled, the system immediately identifies the correct space with an arrow 910 and the amount of time remaining 920. Alternatively, the system could highlight the correct space. If other users are utilizing the same system, it would also be possible to immediately alert the user as to who has already arrived for the meeting via a summary 930. This could be presented to the user over the image of the space. Other features that could be provided include additional information about the other participants in the meeting, room temperatures including identifying the rooms that best meet the user's preferences, suggestions of the best spaces available based on the user's history and other features. Additional information could also be provided by having access to the user's calendar and other applications. For example, the system could recognize the subject of the meeting and provide a summary of prior meetings to help facilitate a quicker start for the user, it could also provide documents related to the meeting subject or documents attached to the meeting notice, it could also indicate other participants who are not yet available and prompt the user to call or send a prompt to the other participants to ensure they join the session, the system could also initiate electronic communications via phone, videoconferencing or network connections to ensure the meeting will start in a timely manner. Other digital connections can be envisioned to facilitate the meeting and save time and effort for the users. This is not meant to be an exhaustive list but simply exemplary of the features that can be added when the system can identify the individual user and the various characteristics of rooms.

An alternative way to identify the spaces is to provide radio frequency beacons that would broadcast a signal comprising a room identifier. A user's personal electronic device 800 would then receive this signal to identify the spaces. This could be done via standard Bluetooth low energy (BLE) beacons. This could also be accomplished by broadcasting a signal identifying the spaces using a high frequency sound. This could be done at a frequency above normal human hearing but still at a range that may be picked up by microphones in standard personal electronic devices 800.

Once the user's personal device has detected the identifier for the space, it may utilize a database tool to identify the associated room. This database tool is then used to look up the room in the calendaring software as discussed previously. The calendar information for each space may then be provided as a visual overlay over the image of the rooms. The display of personal electronic device 800 looking at room 1660 is shown in FIG. 14. In this example, the room is available for use. The user would be able to walk over and make use of the room or the user could press a “USE NOW” button 1810 in order immediately to reserve the space. The user would then be presented with a slider 1820 as shown in FIG. 15 that may be used to increase the amount of time desired for this reservation. In the example shown, the user has selected 15 minutes for the time desired in this space.

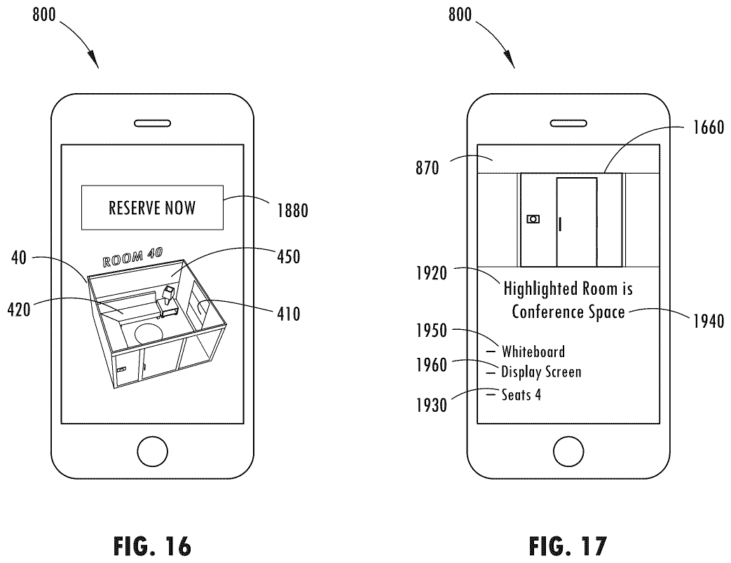

The application could also provide details about the amenities available in the spaces. For example, if the user presses a “Room Details” button 1830 as shown in FIG. 15, the display shifts from an augmented view to an image of an actual room 40 as shown in FIG. 16. In this example, room 40 is shown in plan view allowing the user to identify the various amenities including lounge seating 420, a whiteboard 450 and a presentation screen 410. The user may also see that there are two seats in the room. Thus, if the user is looking for an informal space for no more than two people, this space would be suitable and could be reserved by selecting the “Reserve Now” button 1880.

An alternative to this approach to showing amenities is shown in FIG. 17 showing screen 870 of personal electronic device 800 viewing room 1660. In this example, the augmented view includes a list of the basic amenities 1920 including the number of seats 1930, the type of space 1940, the whiteboard 1950 and the display screen 1960. This allows the user quickly to identify spaces that are suitable to their needs and to make the reservation.

An alternative room scheduling device could be provided via the personal electronic device 800 and identify the various spaces 20, 30, 40, 50, 60 via use of NFC, RFID tag, QR or similar code that may be used to identify the space. The personal electronic device 800 may then use the code or linked information to identify the space and retrieve room reservation information as discussed in detail above. A similar interface to that previously discussed could be used to allow the user to reserve the space or see upcoming reservations.

The current approach to a room scheduling device could also apply in a number of other applications. The present invention is useful in any situation where users wish to schedule or reserve utility objects or spaces. For example, in fitness gyms it is common to wish to reserve equipment or to identify that a user is utilizing the device even if they had to leave momentarily. In this situation, the room scheduling device could be used to quickly and easily make a reservation and identify the equipment is in use. This could similarly be used to identify when spaces are in use in a restaurant or coffee shop. The user could make the reservation locally or in advance of visiting the establishment. Of course, the detection of the presence of the user would be important in this situation to release the reservation if the person making the reservation does not arrive within a specified amount of time. This invention could also be used for spaces such as lounge chairs or similar spaces in a resort or cruise ship application. The invention could also be used to identify reservations on devices such as a rental bicycle or automobile, letting other users know it is not available or it is reserved at some point in the future.

1. An affordance reservation system associated with an affordance comprising:
an affordance display adjacent the affordance, the affordance display presenting a dynamic indication of scheduled use of the affordance;
an affordance identifier located adjacent the dynamic indication of the scheduled occupancy, the affordance identifier being unique to the affordance;
a scanning device including a processor, a device display and a camera including a field of view (FOV), the camera for imaging the affordance identifier to obtain affordance identifying information therefrom, the processor linked to the camera and the display and programmed to perform the steps of:
using identifying information obtained from the camera to identify the affordance;
accessing affordance scheduling information associated with the identified affordance;
generating a schedule representation of the affordance scheduling information; and
presenting the schedule representation via the device display.

2. The system of claim 1 wherein the processor is further programmed to present a real time video image of the affordance identifier via the device display.

3. The system of claim 2 wherein the step of presenting the schedule representation includes presenting the schedule representation as an overlay over the video image of the affordance identifier.

4. The system of claim 3 wherein the processor is further programmed to continue presenting the schedule representation via the device display as the camera is moved away from being aimed at the affordance identifier.

5. The system of claim 3 wherein the schedule representation includes information indicating a current reservation state of the affordance.

6. The system of claim 3 wherein the schedule representation includes information indicating a current state of use of the affordance.

7. The system of claim 3 wherein the affordance includes a facility space and wherein the processor is further programmed to, subsequent to identifying the space, access affordance information related to other affordances located within the space, generate a space affordance representation and present the space affordance representation via the device display.

8. The system of claim 7 wherein the affordance representation includes an image of the space.

9. The system of claim 8 wherein the affordance representation is presented simultaneously with the schedule representation.

10. The system of claim 8 wherein the processor determines if the space is currently unscheduled and wherein the schedule representation includes a selectable button for reserving the space for a current period.

11. The system of claim 7 wherein the affordance representation includes a list of affordances associated with the space.

12. The system of claim 1 wherein the processor is further programmed to receive a command via the scanning device to schedule immediate use of the affordance and wherein, upon receiving a command to schedule immediate use of the affordance, the scanning device transmits a message causing the affordance display to indicate that the affordance is in use.

13. The system of claim 12 wherein the step of indicating that the affordance is in use includes indicating the remaining time during which the affordance is scheduled to be used.

14. The system of claim 1 wherein the scanning device is a portable computing device.

15. The system of claim 1 wherein the affordance identifier includes a visual pattern located adjacent the affordance.

16. The system of claim 15 wherein the pattern includes a unique set of marks.

17. The system of claim 1 wherein the affordance is a first space, the affordance display is a first affordance display, and the affordance identifier is a first affordance identifier, wherein a second affordance is proximate the first affordance, the system including a second affordance display adjacent the second affordance, the second affordance display presenting a second dynamic indication of the scheduled use of the second affordance, a second affordance identifier located adjacent the dynamic indication of the scheduled use of the second affordance, wherein the camera images each of the first and second affordance identifiers at the same time and uses that information to identify each of the first and second affordances.

18. The system of claim 17 wherein the processor is further programmed to perform the steps of, upon identifying each of the first and second affordances, accessing scheduling information for the first and second affordances and determine if a user of the scanning device is scheduled to use either one of the first and second affordances, the step of presenting the schedule representation including indicating the one of the first and second affordances on the device display.

19. An affordance scheduling system associated with a plurality of affordances within a facility, the scheduling system comprising:
a separate affordance identifier located adjacent each of the plurality of affordances within the facility, each affordance identifier being unique to an associated one of the affordances;
a scanning device including a processor, a device display and a camera having a field of view (FOV), the camera for obtaining images within the facility, the processor linked to the camera and the display and programmed to perform the steps of:
receiving images generated by the camera;
presenting the images generated by teh camera via the device display;
examining the images to identify affordance identifiers within the images;
upon identifying at least one of the affordance identifiers, identifying an affordance associated with the identified affordance identifier;
determining that a user of the scanning device is scheduled to use the identified affordance; and
while the identified affordance is located within the camera FOV, visually distinguishing the identified affordance from other affordances that appear within the field of view.

20. A space reservation system associated with a space comprising:
an affordance identifier located adjacent the affordance, the affordance identifier being unique to the affordance;
a scanning device including a processor, a device display and a camera having a field of view (FOV), the processor linked to the camera and the display and programmed to perform the steps of:
presenting a dynamic real time image captured by the camera via the device display;
identifying the affordance identifier within the images generated by the camera;
using identifying information obtained from the affordance identifier to identify the affordance;
accessing affordance scheduling information associated with the identified affordance;
generating a schedule representation of the affordance scheduling information;
while the affordance identifier remains within the camera FOV, presenting the schedule representation as an augmented reality overlay over the image including the affordance identifier;
providing a hold button via the scanning device; and
upon activation of the hold button, persistently presenting the schedule representation via the device display irrespective of whether or not the affordance identifier remains within the camera FOV.
